(19) United States
(12) Patent Application Publication
(10) Pub. No.: US 2017/0313399 A1
(43) Pub. Date: Nov. 2, 2017

(54) WATERCRAFT DRAG APPARATUS

(71) Applicant: Paul J. Thomas, Baltimore, OH (US)

(72) Inventor: Paul J. Thomas, Baltimore, OH (US)

(21) Appl. No.: 15/583,979

(22) Filed: May 1, 2017

Related U.S. Application Data
(60) Provisional application No. 62/329,975, filed on Apr. 29, 2016.

(51) Int. Cl. B63H 25/44; B63B 1/30; G05D 1/02; B63H 25/02

(52) U.S. Cl. CPC B63H 25/44; G05D 1/0206; B63H 25/02; B63B 1/30; B63B 2719/00; B63H 2025/026; B63H 2025/024

(57) ABSTRACT

A watercraft drag apparatus may extend into the water from either the port or the starboard side of a watercraft or a hull of the watercraft. The drag apparatus may cause an increase in drag on one side of the watercraft. The increase in drag may slow the watercraft to a slower speed than the watercraft can typically maintain under normal power. The increase in drag may also cause the watercraft to change heading, requiring a watercraft pilot to repeatedly correct the heading to maintain an intended course. The watercraft drag apparatus may be useful for fishing, such as when trolling.

### CROSS-REFERENCE TO RELATED APPLICATIONS

This application claims priority from U.S. Provisional Patent Application No. 62/329,975, filed on Apr. 29, 2016, which is incorporated by reference herein in its entirety.

### BACKGROUND

When fishing, one may choose to fish from a watercraft, such as a boat, rather than from land. When fishing from a watercraft, it may be desirable to control at least one of the speed and the direction of the watercraft. For example, one may need to control the speed and the direction of the watercraft to properly navigate the watercraft.

Moreover, one may need to control the speed and the direction of the watercraft to properly position and/or manipulate the movement of a lure deployed in the water by a fishing rod. For example, different species of game fish may respond differently to various lure movements in the water. As a result, one who fishes may utilize a method commonly known as trolling, which requires the operator of the watercraft to slow the watercraft—perhaps as slow as 9 knots or less—and execute a series of port and starboard turns to slowly zig-zag across a body of water. Such slow, back-and-forth motions cause the lure to vertically climb and dive in the water, or fall and sink in the water, thereby catching the attention of various species of game fish. The fishing rod to which the lure is attached may be mounted on the watercraft (for example, off the port or starboard side, or off the stern) with a fixed amount of fishing line deployed, thus acting as a static line attaching the lure to the watercraft.

When trolling, one may use a watercraft with a small trolling motor that is designed to propel the watercraft slowly. Some may use a watercraft that has two motors, such as a relatively large motor for cruising, and a relatively small motor for trolling. However, watercraft with two motors may be cost prohibitive, and often the small trolling motor requires use of a battery, which may be cumbersome and require maintenance. Likewise, watercraft with only one motor may be too slow for cruising or too fast for trolling.

One fishing from a watercraft may find it desirable to automatically control the speed and/or the direction of the watercraft in response to the desired position and/or movement of the lure. One fishing from a watercraft may find it desirable to have assistance with controlling the speed and/or the direction of the watercraft to achieve the desired position and/or movement of the lure.

A device may be deployed from a watercraft into the water that may affect at least one of the speed and the direction of the watercraft. For example a rudder may extend from the watercraft into the water and may be used to control the direction of the watercraft. The rudder may be a flat or curved fin-like device that is operatively connected to the stern of the watercraft to allow for port and starboard movement. Specifically, when the rudder is positioned to extend in the starboard direction, the watercraft may turn into the starboard direction. However, a rudder may not sufficiently slow the watercraft

What is need is a watercraft drag apparatus for assisting one fishing from a watercraft in controlling at least one of the speed and the direction of the watercraft. Specifically, a watercraft drag apparatus is needed that can sufficiently slow a watercraft with a motor that is too large to propel the watercraft at slow trolling speeds, as well as manipulate the direction of travel of the watercraft so as to require the operator of the watercraft to execute a series of port and starboard turns.

### SUMMARY

In one embodiment, a drag apparatus for a watercraft is provided, the drag apparatus comprising: a mounting device, including at least one clamp, and two frame members having a channel between the frame members; at least one control surface oriented within the channel; wherein the at least one clamp extends around a portion of a hull of the watercraft; wherein the at least one control surface is configured to translate between a stowed position and a deployed position; wherein the at least one control surface is configured to disrupt a flow of water around at least one side of the watercraft; and wherein the disruption of flow of water causes the watercraft to decrease in speed and to change heading.

In one embodiment, a watercraft including a drag apparatus is provided, the watercraft comprising: a hull; a mounting device, including at least one clamp, and two frame members having a channel between the frame members; at least one control surface oriented within the channel; wherein the at least one clamp extends around a portion of the hull; wherein the at least one control surface translates between a stowed position and a deployed position; wherein the at least one control surface disrupts a flow of water around at least one side of the watercraft; and wherein the disruption of flow of water causes the watercraft to decrease in speed and to change heading.

In another embodiment, a drag apparatus for a watercraft may have at least one control surface configured to extend from the watercraft into a body of water. The at least one control surface may be configured to extend from at least one of the port side and the starboard side of the watercraft. The at least one control surface may be configured to disrupt a flow of water around at least one of the port side and the starboard side of the watercraft. The at least one control surface may have a stowed position, at least one partially deployed position, and at least one deployed position. The disruption of flow of water may cause the watercraft to decrease in speed and to change heading. The drag apparatus may have a control device, which may have a first control end and a second control end. The first control end may be configured to be operated by a watercraft pilot. The second control end may be operatively connected to the at least one control surface. The control device may be configured to move the at least one control surface to and from at least one of: the stowed position, the at least one partially deployed position, and the at least one deployed position.

In another embodiment, a drag apparatus for a watercraft may have at least one control surface configured to extend from the watercraft into a body of water. The at least one control surface may be configured to extend from at least one of the port side and the starboard side of the watercraft. The at least one control surface may be configured to disrupt a flow of water around at least one of the port side and the starboard side of the watercraft. The at least one control surface may have a stowed position, at least one partially deployed position, and at least one deployed position. The disruption of flow of water may cause the watercraft to decrease in speed and to change heading. The drag apparatus may have a mounting device, which may have a first mounting end and a second mounting end. The first mounting end may be operatively connected to the watercraft. The second mounting end may be operatively connected to the at least one control surface. The mounting device may be configured to allow the at least one control surface to extend from the watercraft by at least one of: a rotation and a translation. The drag apparatus may have a control device, which may have a first control end and a second control end. The first control end may be configured to be operated by a watercraft pilot. The second control end may be operatively connected to the at least one control surface. The control device may be configured to move the at least one control surface to and from at least one of: the stowed position, the at least one partially deployed position, and the at least one deployed position.

A watercraft having a drag apparatus may have a hull and at least one control surface configured to extend from the hull into a body of water. The at least one control surface may be configured to extend from at least one of the port side and the starboard side of the hull. The at least one control surface may be configured to disrupt a flow of water around at least one of the port side and the starboard side of the hull. The at least one control surface may have a stowed position, at least one partially deployed position, and at least one deployed position. The disruption of flow of water may cause the watercraft to decrease in speed and change heading. The watercraft may have a mounting device, which may have a first mounting end and a second mounting end. The first mounting end may be operatively connected to the hull. The second mounting end may be operatively connected to the at least one control surface. The mounting device may be configured to allow the at least one control surface to extend from the hull by at least one of: a rotation and a translation. The watercraft may have a control device, which may have a first control end and a second control end. The first control end may be configured to be operated by a watercraft pilot. The second control end may be operatively connected to the at least one control surface. The control device may be configured to move the at least one control surface to and from at least one of: the stowed position, the at least one partially deployed position, and the at least one deployed position.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a plan view of a first embodiment of a drag apparatus for a watercraft.

FIG. 2 illustrates a plan view of a second embodiment of a drag apparatus for a watercraft.

FIG. 3 illustrates a plan view of a third embodiment of a drag apparatus for a watercraft.

FIG. 4 illustrates a plan view of a fourth embodiment of a drag apparatus for a watercraft.

FIG. 5 illustrates a plan view of a fifth embodiment of a drag apparatus for a watercraft.

FIG. 6 illustrates a plan view of a sixth embodiment of a drag apparatus for a watercraft.

FIG. 7 illustrates an elevation view of a first embodiment of a drag apparatus for a watercraft.

FIG. 8 illustrates an elevation view of a first embodiment of a drag apparatus for a watercraft.

FIG. 9 illustrates an elevation view of a first embodiment of a drag apparatus for a watercraft.

FIG. 10 illustrates an elevation view of a second embodiment of a drag apparatus for a watercraft.

FIG. 11 illustrates an elevation view of a second embodiment of a drag apparatus for a watercraft.

FIG. 12 illustrates a side elevation view of a third embodiment of a drag apparatus for a watercraft.

FIG. 13 illustrates a bottom plan view of a third embodiment of a drag apparatus for a watercraft.

FIG. 14 illustrates a top plan view of a third embodiment of a drag apparatus for a watercraft.

FIG. 15 illustrates a front elevation view of a third embodiment of a drag apparatus for a watercraft in a retracted position.

FIG. 16 illustrates a front elevation view of a third embodiment of a drag apparatus for a watercraft in an extended position.

FIG. 17 illustrates a front perspective view of a third embodiment of a drag apparatus mounted on a watercraft in an extended position.

### DETAILED DESCRIPTION

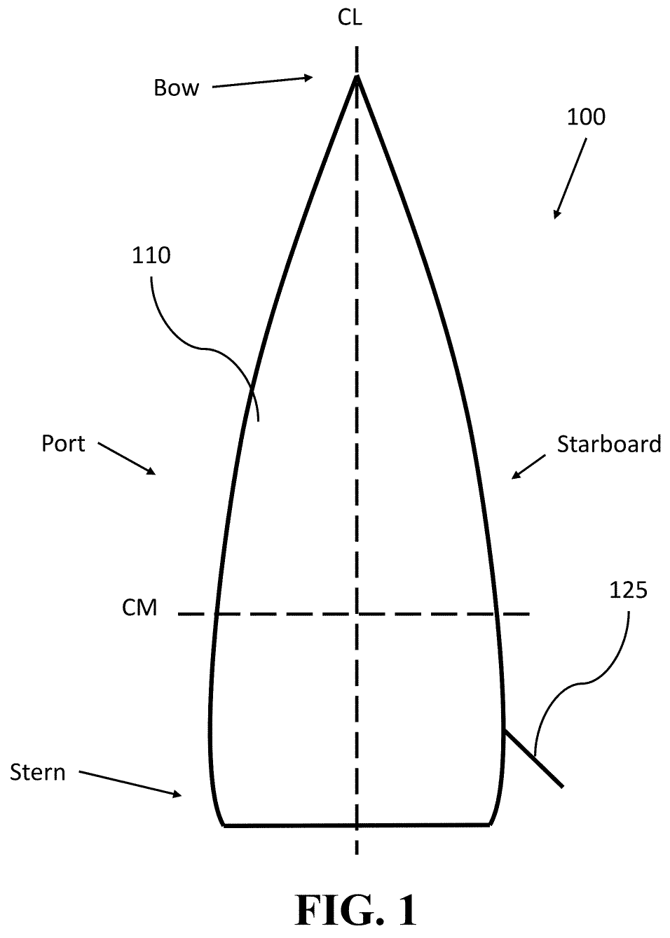

FIG. 1 illustrates a plan view of an example embodiment of a watercraft 100 having a hull 110 and a drag apparatus 125. Hull 110 may have a centerline CL extending from its bow to its stern and dividing hull 110 into equal port and starboard sides. Hull 110 may have a center of mass line CM extending from port to starboard through the watercraft's center of mass.

Watercraft 100 may be a boat. Watercraft 100 may be a fishing boat. Watercraft may be any type of boat, ship, or other vehicle having a positive buoyancy in water.

Watercraft 100 may have a motor (not shown). The motor may range from a low-powered trolling motor, such as an electric motor, to a high-powered racing motor, such as a gas, diesel, or kerosene motor. When fishing for various species of game fish, it may be desirable to decrease the speed of watercraft 100 to a speed that is slower than watercraft 100 can maintain when powered by its motor. Under such circumstances, drag apparatus 125 may be deployed into a body of water to cause a drag force by disrupting the flow of water around watercraft 100 and thereby slowing the speed of watercraft 100 to a speed slower than its motor can normally maintain.

Drag apparatus 125 may have a stowed position (not shown) such that drag apparatus 125 causes zero drag force, substantially zero drag force, or little drag force. More specifically, the stowed position may be suitable for normal cruising and maneuvering as though drag apparatus 125 were not present. The stowed position may be a position whereby drag apparatus 125 is completely out of the water, partially out of the water, or completely in the water.

Drag apparatus 125 may have at least one partially deployed position, as illustrated in FIG. 1, such that drag apparatus 125 causes an appreciable drag force sufficient to at least one of: slow watercraft 100 and change the heading of watercraft 100. The at least one partially deployed position may be a position whereby drag apparatus 125 is partially out of the water or completely in the water. The at least one partially deployed position may include all positions of drag apparatus 125 between its minimum and maximum range of motion. The at least one partially deployed position may include all positions of drag apparatus 125 between 0° and 90° as measured from the heading of watercraft 100 and a control surface (not shown) of drag apparatus 125.

Drag apparatus 125 may have at least one deployed position such that drag apparatus 125 causes a maximum drag force sufficient to at least one of: slow watercraft 100 and change the heading of watercraft 100. The at least one deployed position may be a position whereby drag apparatus 125 is partially out of the water or completely in the water. The at least one deployed position may include all positions of drag apparatus 125 at its maximum range of motion. For example, drag apparatus 125 may have a port deployed position and a starboard deployed position. The at least one deployed position may include drag apparatus 125 at 90° as measured from the heading of watercraft 100 and the control surface of drag apparatus 125.

Drag apparatus 125 may extend into the water from at least one of the port side and the starboard side of watercraft 100. Drag apparatus 125 may have a control surface (not shown) suitable for causing a drag force in water, such as a circle, an oval, a square, a rectangle, a triangle, a polygon having any number of sides, a fin, and any other irregular shape that has a surface area. Drag apparatus 125 may have a profile that is angled, curved, or flat. Drag apparatus 125 may have any shape that may cause some degree of drag when extended into the water from either the port or the starboard side of watercraft 100.

When deployed into the water, drag apparatus 125 may disrupt the flow of water around watercraft 100 and thereby cause watercraft 100 to change heading. For example, when drag apparatus 125 is deployed by extending drag apparatus 125 into the water from the starboard side of watercraft 100, watercraft 100 may change its heading (i.e., turn) into the starboard direction. This cause and effect relationship may be maximized when drag apparatus 125 is positioned in the stern portion of on watercraft 100. The stern portion may include the portion of watercraft 100 aft of center of mass line CM (i.e., from center of mass line CM to the stern). For example, FIG. 1 illustrates drag apparatus 125 positioned on watercraft 100 between center of mass line CM and the stern.

In one embodiment, drag apparatus 125 may also include a control device (not shown) configured to control the position of drag apparatus 125. The control device may have a first control end and a second control end. The first control end may be configured to be operated by a watercraft pilot. The first control end may include at least one of: a lever, a latch, a shaft, a handle, an electrical circuit, a mechanical actuator, a hydraulic actuator, an electric actuator, and the like. The first control end may have any configuration that allows the watercraft pilot to control the position of drag apparatus 125.

The control device may have a second control end. The second control end may be operatively connected to the at least one control surface. The second control end may be operatively connected to the at least one control surface by at least one of: a bolt, a screw, a rivet, a pin, a weld, a hinge, a pivot, and the like. The second control end may be operatively connected to the at least one control surface by any connection sufficient to allow the watercraft pilot to move the at least one control surface to at least one of: the stowed position, the at least partially deployed position, and the at least one deployed position.

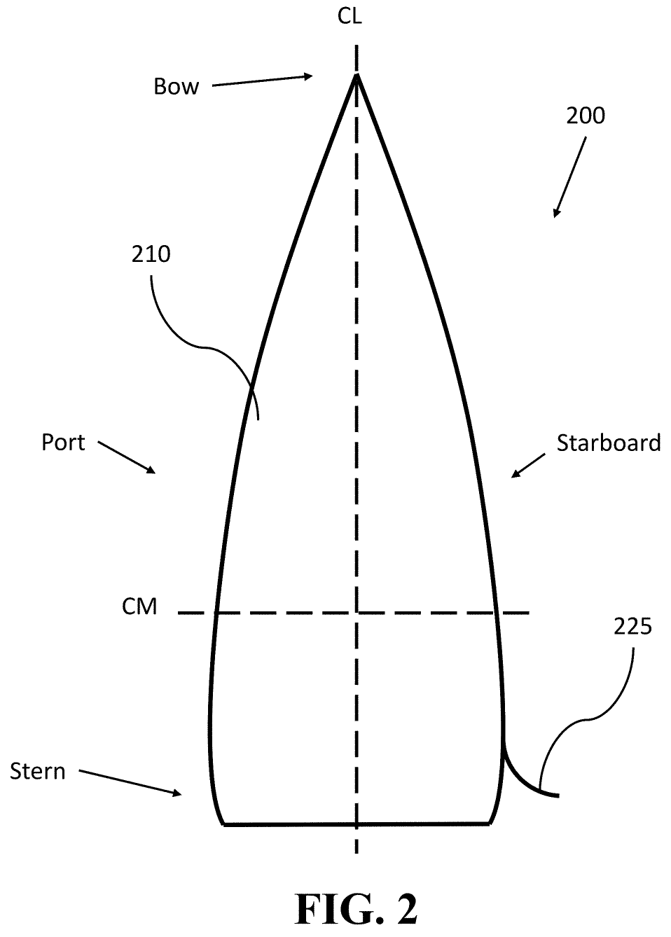

FIG. 2 illustrates a plan view of an example embodiment of a watercraft 200 having a hull 210 and a drag apparatus 225. Hull 210 may have a centerline CL extending from its bow to its stern and dividing hull 210 into equal port and starboard sides. Hull 210 may have a center of mass line CM extending from port to starboard through the watercraft's center of mass. As illustrated in FIG. 2, drag apparatus 225 may have a curved profile and may be positioned on watercraft 200 between the center of mass line CM and the stern. Drag apparatus 225 may share characteristics, features, and the like with drag apparatus 125.

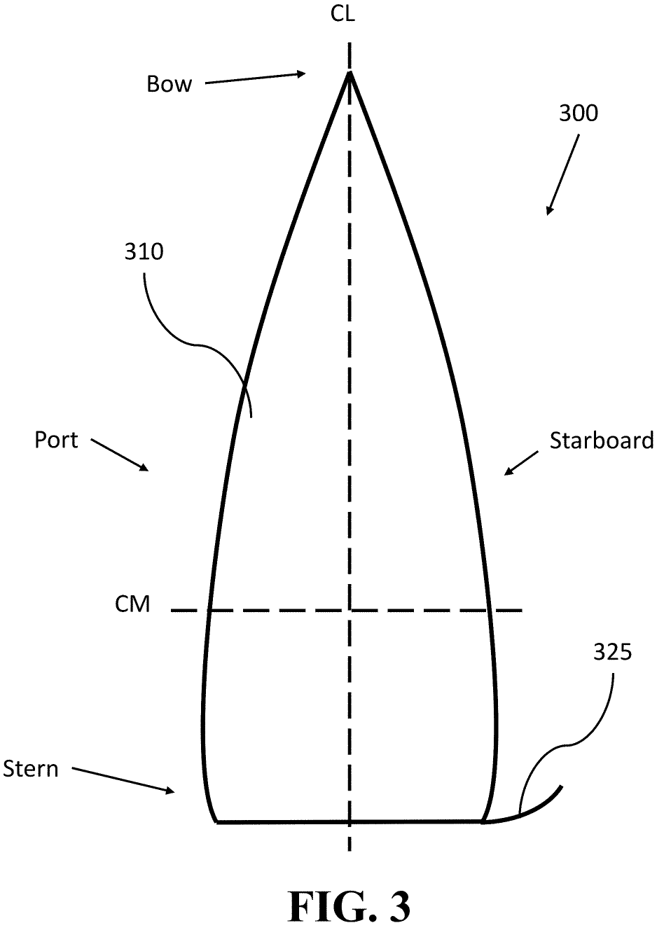

FIG. 3 illustrates a plan view of an example embodiment of a watercraft 300 having a hull 310 and a drag apparatus 325. Hull 310 may have a centerline CL extending from its bow to its stern and dividing hull 310 into equal port and starboard sides. Hull 310 may have a center of mass line CM extending from port to starboard through the watercraft's center of mass. As illustrated in FIG. 3, drag apparatus 325 may have a curved profile and may be positioned on watercraft 300 between the center of mass line CM and the stern. Drag apparatus 325 may share characteristics, features, and the like with drag apparatus 125. Drag apparatus 325 may be oriented upon or operatively connected to the transom of watercraft 300.

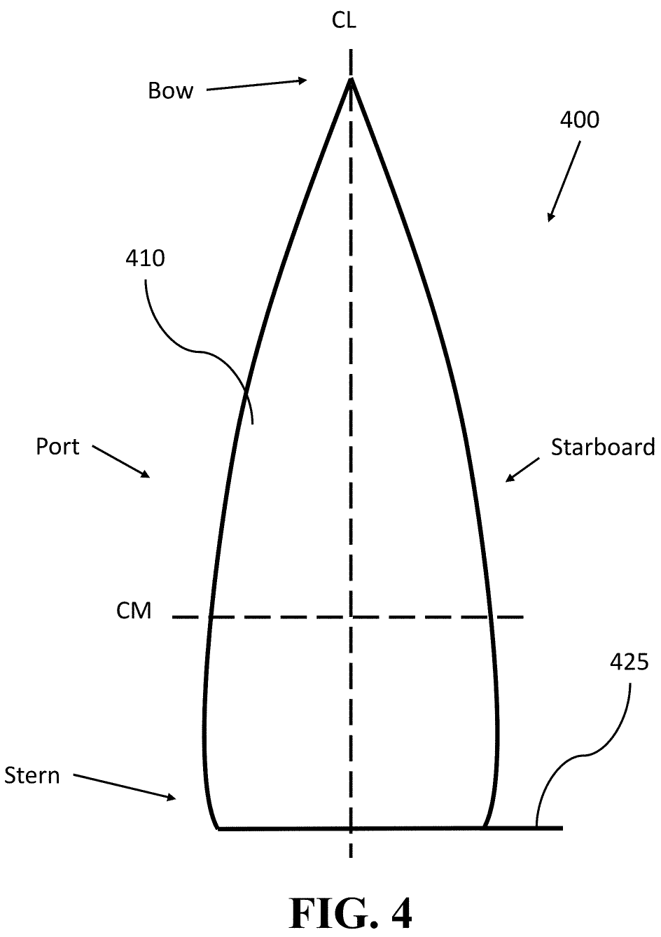

FIG. 4 illustrates a plan view of an example embodiment of a watercraft 400 having a hull 410 and a drag apparatus 425. Hull 410 may have a centerline CL extending from its bow to its stern and dividing hull 410 into equal port and starboard sides. Hull 410 may have a center of mass line CM extending from port to starboard through the watercraft's center of mass. As illustrated in FIG. 4, drag apparatus 425 may have a flat profile and may be positioned on watercraft 400 at the stern. Drag apparatus 425 may share characteristics, features, and the like with drag apparatus 125. Drag apparatus 425 may be oriented upon or operatively connected to the transom of watercraft 400.

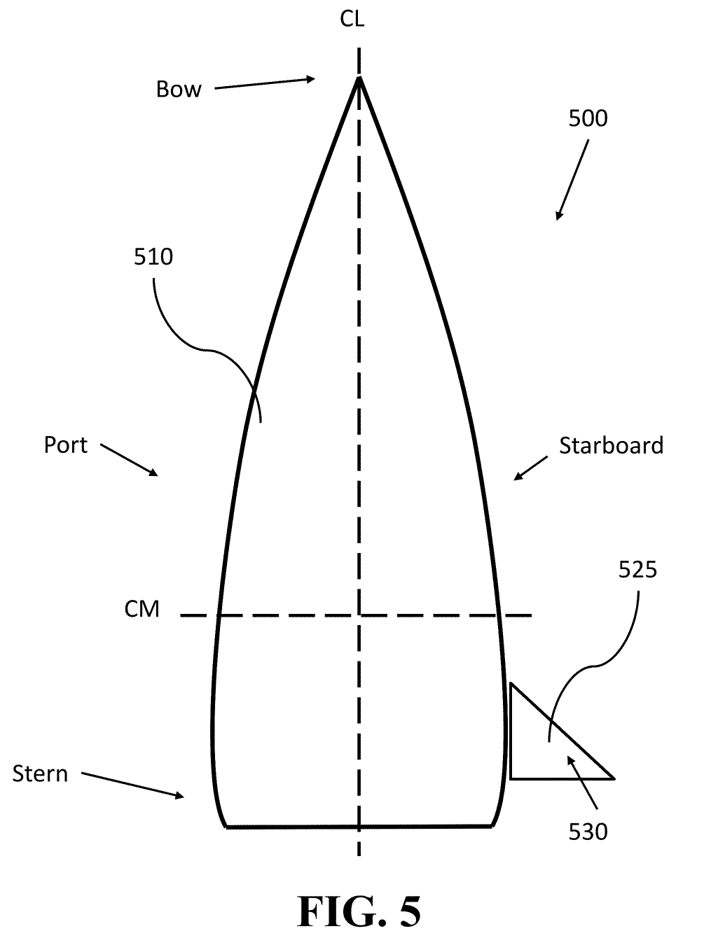

FIG. 5 illustrates a plan view of an example embodiment of a watercraft 500 having a hull 510 and a drag apparatus 525. Hull 510 may have a centerline CL extending from its bow to its stern and dividing hull 510 into equal port and starboard sides. Hull 510 may have a center of mass line CM extending from port to starboard through the watercraft's center of mass. Drag apparatus 525 may share characteristics, features, and the like with drag apparatus 125.

In one embodiment, drag apparatus 525 may have a control surface 530. Control surface 530 may have a triangular shape. As illustrated in FIG. 5, drag apparatus 525 may be in a stowed position such that control surface 530 is rotated out of the flow of water, thereby minimizing the drag force caused by drag apparatus 525. That is, control surface 530 may be oriented such that it slices through the water like a blade when stowed, presenting a thin cross-section to the water in the direction of travel. Drag apparatus 525 may be positioned on watercraft 500 between the center of mass line CM and the stern. Control surface 530 may be positioned on watercraft 500 at the stern.

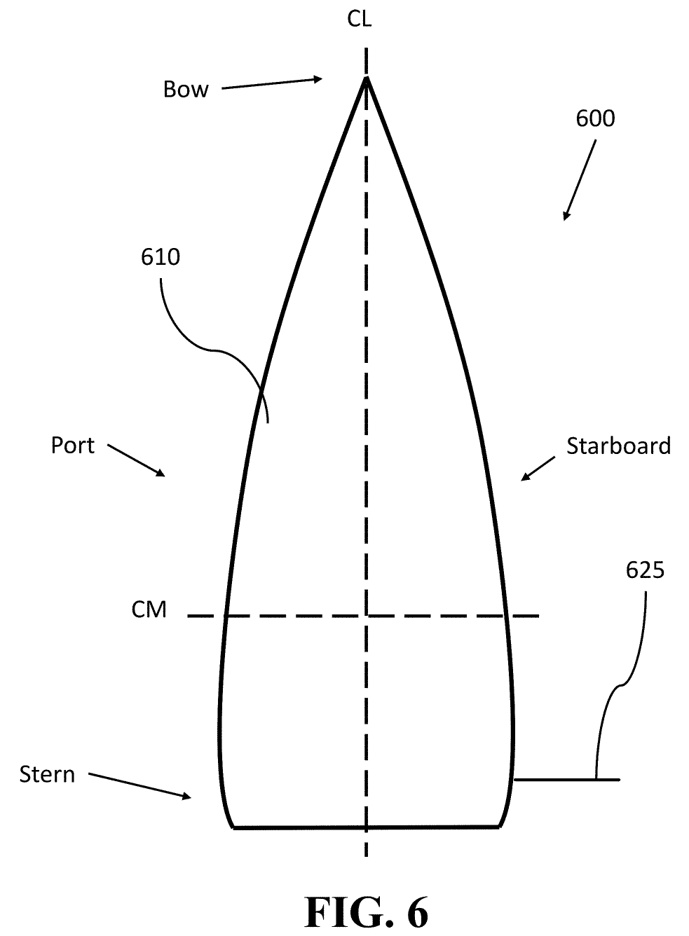

FIG. 6 illustrates a plan view of an example embodiment of a watercraft 600 having a hull 610 and a drag apparatus 625. Hull 610 may have a centerline CL extending from its bow to its stern and dividing hull 610 into equal port and starboard sides. Hull 610 may have a center of mass line CM extending from port to starboard through the watercraft's center of mass. Drag apparatus 625 may share characteristics, features, and the like with drag apparatus 125.

In one embodiment, drag apparatus 625 may have a control surface (not shown). The control surface may have a triangular shape. As illustrated in FIG. 6, drag apparatus 625 may be a plan view of drag apparatus 525, as illustrated in FIG. 5. However, drag apparatus 625 may be in a deployed position such that control surface 630 is rotated into the flow of water, thereby maximizing the drag force caused by drag apparatus 625. That is, control surface 630 may be oriented such that its large cross-section is presented in the direction of travel. As a result of the configuration illustrated in FIG. 6, watercraft 600 may slow and turn to starboard.

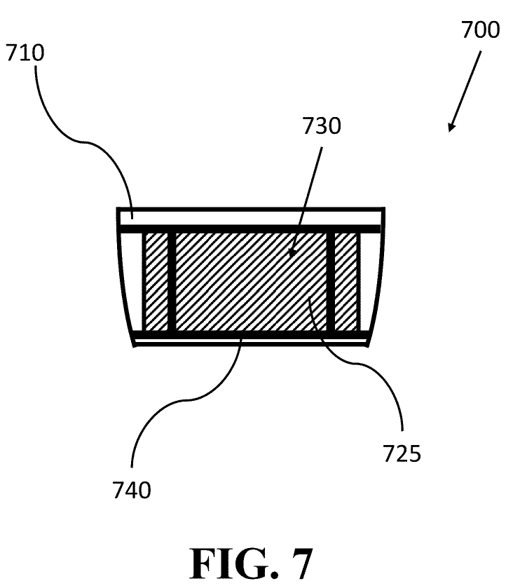

FIG. 7 illustrates an elevation view of an example embodiment of a watercraft 700 having a hull 710. Watercraft 700 may have a drag apparatus 725. Drag apparatus 725 may have at least one control surface 730. Drag apparatus may have a control device (not shown).

In one embodiment, drag apparatus 725 may have a mounting device 740. Mounting device 740 may have a first mounting end (not shown) and a second mounting end (not shown). The first mounting end may be operatively connected to watercraft 725. The first mounting end may be operatively connected to watercraft 725 by at least one of: a bolt, a screw, a rivet, a pin, a weld, and the like. The first mounting end may be operatively connected to watercraft 725 by any connection sufficient to allow drag apparatus 725 to resist the drag force caused by drag apparatus 725 and allow drag apparatus 725 to remain operatively connected to watercraft 725.

The second mounting end of mounting device 740 may be operatively connected to at least one control surface 730. The second mounting end may be operatively connected to at least one control surface 730 by at least one of: a bolt, a screw, a rivet, a pin, a weld, a hinge, a rail, an axle, a bearing, and the like. The second mounting end may be operatively connected to at least one control surface 730 by any connection that allows at least one control surface 730 to extend from watercraft 725 by at least one of: a rotation and a translation.

In one embodiment, mounting device 740 is a track in which control surface 730 may translate, rotate, or the like.

In one embodiment, mounting device 740 may be configured to allow drag apparatus 725 to translate in a plane perpendicular to a centerline (not shown) of hull 710. Drag apparatus 725 may translate from a stowed position to at least one of a port or a starboard deployed position. Drag apparatus 725 may translate from a stowed position to at least one of a port or a starboard partially deployed position or positions.

As illustrated in FIG. 7, drag apparatus 725 may be in the stowed position such that drag apparatus 725 causes zero drag force, substantially zero drag force, or little drag force. More specifically, the stowed position may be suitable for normal cruising and maneuvering as though drag apparatus 725 were not present.

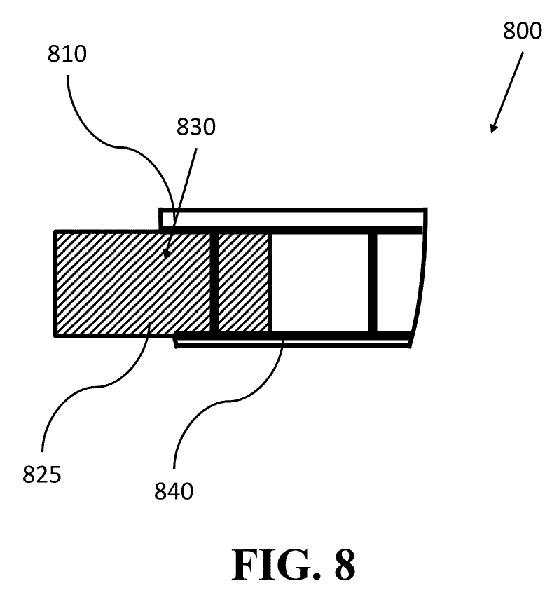

FIG. 8 illustrates a drag apparatus 825, as illustrated in FIG. 7, in a port deployed position such that drag apparatus 825 is positioned in its maximum range of motion to the port side of watercraft 800. Watercraft 800 may include a hull 810. Drag apparatus 825 may have at least one control surface 830. Drag apparatus may have a control device (not shown). In one embodiment, drag apparatus 825 may have a mounting device 840.

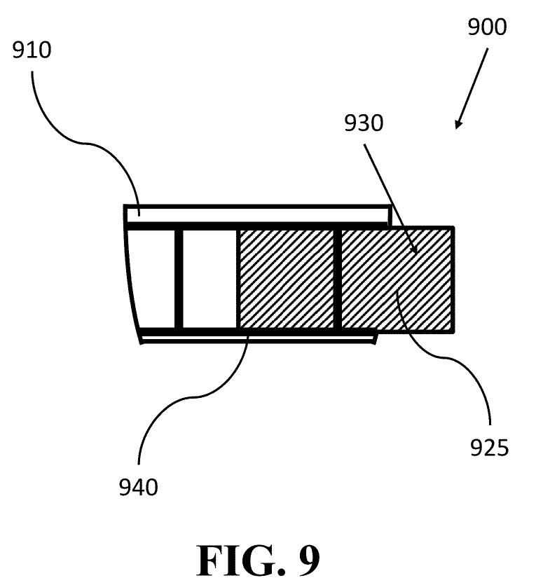

FIG. 9 illustrates a drag apparatus 925, as illustrated in FIG. 7, in a starboard partially deployed position such that drag apparatus 925 is positioned between its minimum and its maximum ranges of motion (i.e., drag apparatus 925 is extended in a position between a stowed position and a deployed position) to the starboard side of watercraft 900. Watercraft 900 may include a hull 910. Drag apparatus 925 may have at least one control surface 930. Drag apparatus may have a control device (not shown). In one embodiment, drag apparatus 925 may have a mounting device 940.

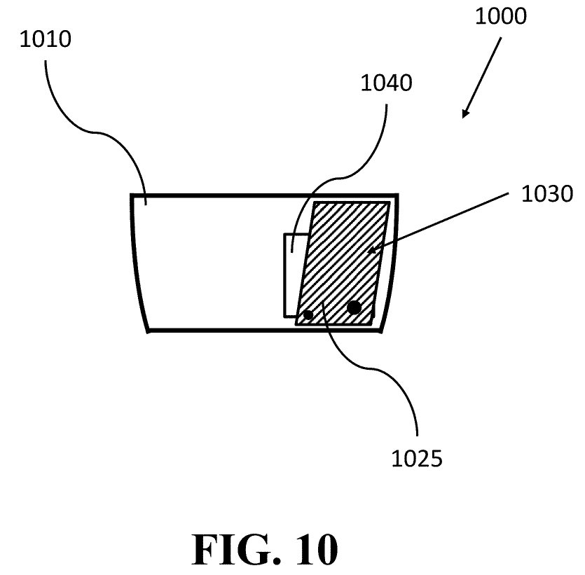

FIG. 10 illustrates an elevation view of an example embodiment of a watercraft 1000 having a hull 1010. Watercraft 1000 may have a drag apparatus 1025. Drag apparatus 1025 may have at least one control surface 1030. Drag apparatus may have a control device (not shown).

In one embodiment, drag apparatus 1025 may have a mounting device 1040. Mounting device 1040 may have a first mounting end (not shown) and a second mounting end (not shown). The first mounting end may be operatively connected to watercraft 1025. The first mounting end may be operatively connected to watercraft 1025 by at least one of: a bolt, a screw, a rivet, a pin, a weld, a hinge, a pivot, and the like. The first mounting end may be operatively connected to watercraft 1025 by any connection sufficient to allow drag apparatus 1025 to resist the drag force caused by drag apparatus 1025 and allow drag apparatus 1025 to remain operatively connected to watercraft 1025.

The second mounting end of mounting device 1040 may be operatively connected to at least one control surface 1030. The second mounting end may be operatively connected to at least one control surface 1030 by at least one of: a bolt, a screw, a rivet, a pin, a weld, a hinge, a rail, an axle, and the like. The second mounting end may be operatively connected to at least one control surface 1030 by any connection that allows at least one control surface 1030 to extend from watercraft 1025 by at least one of: a rotation and a translation.

In one embodiment, mounting device 1040 may be configured to allow drag apparatus 1025 to rotate in a plane perpendicular to a centerline (not shown) of hull 1010. Drag apparatus 1025 may rotate from a stowed position to either a port or a starboard deployed position. Drag apparatus 1025 may translate from a stowed position to either a port or a starboard partially deployed position or positions.

As illustrated in FIG. 10, drag apparatus 1025 may be in the stowed position such that drag apparatus 1025 causes zero drag force, substantially zero drag force, or little drag force. More specifically, the stowed position may be suitable for normal cruising and maneuvering as though drag apparatus 1025 were not present.

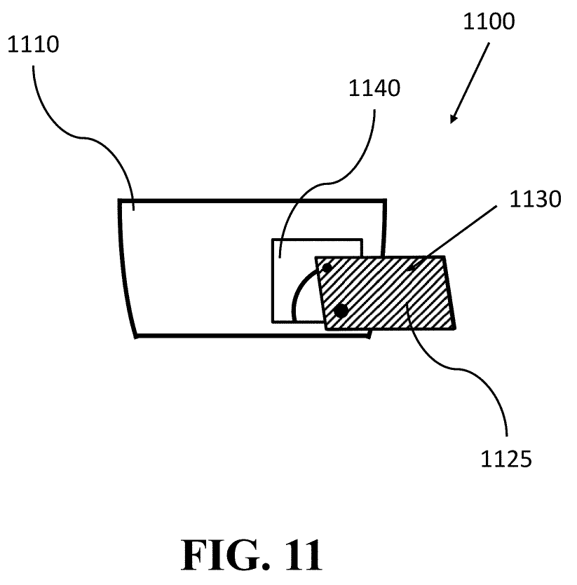

FIG. 11 illustrates a drag apparatus 1125, as illustrated in FIG. 10, in a starboard deployed position such that drag apparatus 1125 is positioned in its maximum range of motion to the starboard side of watercraft 1100. Watercraft 1100 may include a hull 1110. Drag apparatus 1125 may include at least one control surface 1130. In one embodiment, mounting device 1140 may be configured to allow drag apparatus 1125 to rotate in a plane perpendicular to a centerline (not shown) of hull 1110.

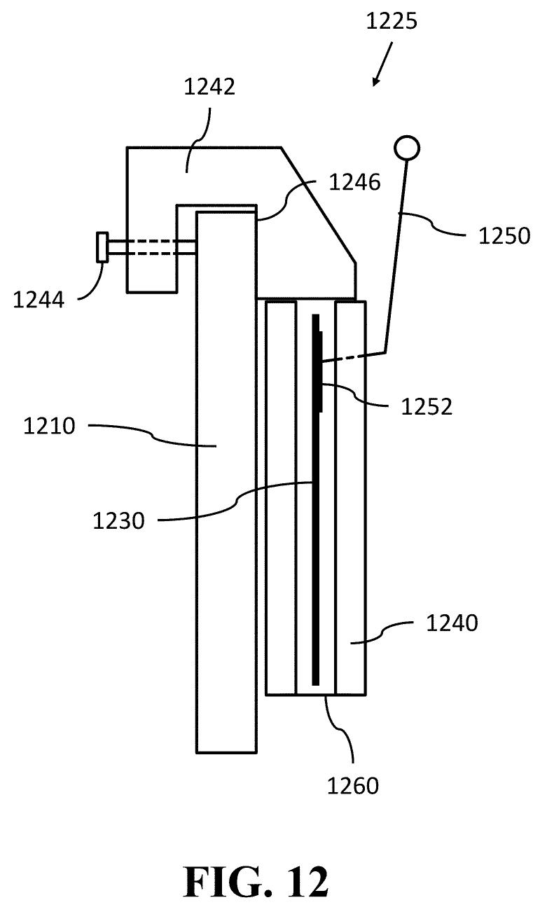

FIG. 12 illustrates a drag apparatus 1225 for a watercraft. Drag apparatus 1225 may attach to a portion of a hull 1210 of a watercraft. Hull 1210 may be a transom. Drag apparatus 1225 may include a control surface 1230. Drag apparatus 1225 may include a mounting device 1240. Drag apparatus 1225 may include a handle 1250. Drag apparatus 1225 may include a lower seal 1260.

Hull 1210 may include any portion of a watercraft's hull. Hull 1210 may include a portion of a watercraft's stern. Hull 1210 may include a portion of a watercraft's transom.

Control surface 1230 may be a substantially planar element, including a width and length at least one order of magnitude greater than its thickness. For example, control surface 1230 may have a length (measured along its longest side) of about 25 in., a width (measured perpendicular to its longest side, and along its second longest side) of about 10 in., and a thickness (measured perpendicular to its length and width) of about 0.25 in.

Mounting device 1240 may include a frame and attachment mechanism for attaching control surface 1230 to hull 1210. Mounting device 1240 may include two generally rectangular frame members with a channel therebetween in which control surface 1230 may translate between a retracted (stowed) position and an extended (deployed or partially deployed) position. For example, mounting device 1240 may include at least one clamp 1242 configured to extend around (e.g., on more than one side of) a portion of hull 1210. Clamp 1242 may extend around a portion of three sides of hull 1210. Clamp 1242 may extend around a portion of two sides of hull 1210.

Clamp 1242 may include a fixation member 1244 configured to apply a force to hull 1210. Fixation member 1244 may be a threaded bolt configured to apply a compression force to hull 1210. In use, one may extend clamp 1242 over a portion of hull 1210, and extend fixation member 1244 toward hull 1210 to cause fixation member to essentially “pinch” hull 1210 between fixation member 1244 and a clamp surface 1246 opposed to fixation member 1244. Fixation member 1244 and clamp surface 1246 may both apply a compression force to hull 1210. Clamp surface 1246 may be a wall of clamp 1242 configured to engage a portion of hull 1210. Clamp surface 1246 may be contoured to engage a specific relevant contour of hull 1210 where on intends to mount drag apparatus 1225. Clamp 1242, including at least one fixation member 1244 and clamp surface 1246 may have dimensions designed to allow mounting of clamp 1242 to a variety of hulls 1210 having a variety of thicknesses.

Drag apparatus 1225 may include handle 1250. Handle 1250 may be configured to allow for the adjustment (e.g., deployment (extension) and stowing (retraction)) of control surface 1230. Handle 1250 may allow for the “locking” of control surface 1230 into a specific position, including for example, full retraction, full extension, or partial extension. Handle 1250 may include a knob and an arm, whereby the arm attaches to control surface 1230. The knob may be configured to be manipulated or gripped by a user.

Handle 1250 may attach to a handle plate 1252, which may be bolted, welded, adhered, or otherwise connected to control surface 1230. Handle 1250 may extend from a planar surface of control surface 1230, including for example a surface facing rearward from the watercraft.

At least a portion of control surface 1230 may be under the waterline of the watercraft when drag apparatus 1225 is connected to a watercraft. All of control surface 1230 may be under the waterline of the watercraft to which drag apparatus 1225 is connected. At least a portion of control surface 1230 may be under the waterline of the watercraft to which drag apparatus 1225 is connected, when the watercraft is underway. All of control surface 1230 may be under the waterline of the watercraft to which drag apparatus 1225 is connected, when the watercraft is underway. Lower seal 1260 may be configured to seal off the lower (e.g., direction into the water) edge of drag apparatus 1225, such that water cannot flow between mounting device 1240 and control surface 1230 from the lower edge, and thus cause water to shoot upwardly (e.g., direction out of the water) and splash watercraft passengers, watercraft equipment, or other portions of the watercraft. Lower seal 1260 may be a plate extending along the lower edge of mounting device 1240 so as to close off the gap between control surface 1230 and mounting device 1240 that may extend to the lower edge of mounting device 1240 in the absence of lower seal 1260. Lower seal 1260 may be a plate extending along an edge of mounting device 1240 opposite the at least one clamp 1242. Lower seal 1260 may seal the channel between the frame members of mounting device 1240.

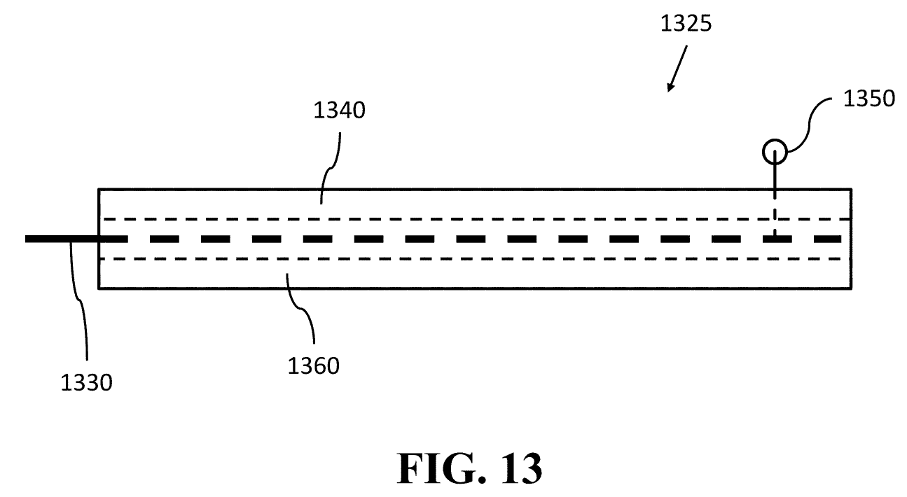

FIG. 13 illustrates a drag apparatus 1325 for a watercraft. Drag apparatus 1325 may attach to a portion of a hull of a watercraft. Drag apparatus 1325 may include a control surface 1330. Drag apparatus 1325 may include a mounting device 1340. Drag apparatus 1325 may include a handle 1350. Drag apparatus 1325 may include a lower seal 1360.

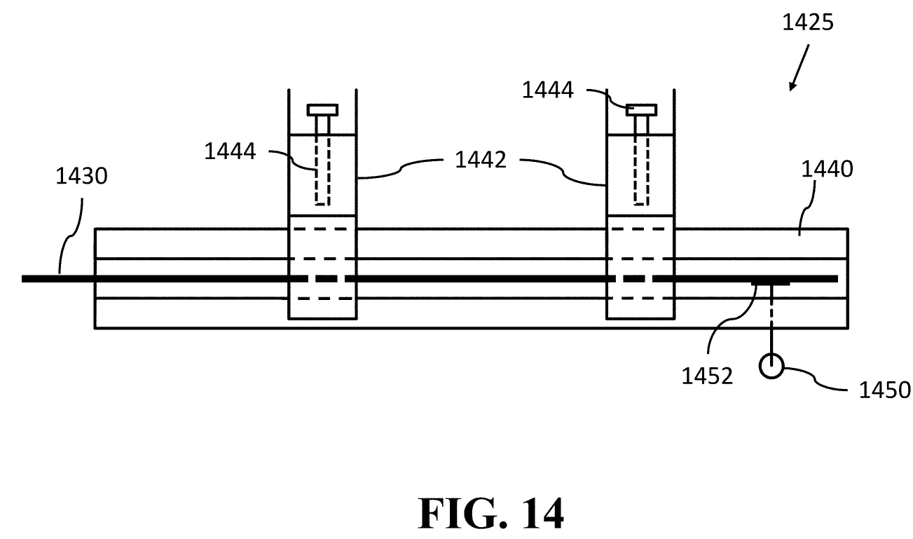

FIG. 14 illustrates a drag apparatus 1425 for a watercraft. Drag apparatus 1425 may attach to a portion of a hull of a watercraft. Drag apparatus 1425 may include a control surface 1430. Drag apparatus 1425 may include a mounting device 1440. Drag apparatus 1425 may include a handle 1450.

Mounting device 1440 may include at least one clamp 1442. At least one clamp may be configured to extend around two or more sides of a hull of a watercraft. At least one clamp may include at least one fixation member 1444.

Handle 1450 may include a handle plate 1452. Handle plate 1452 may connect to control surface 1430.

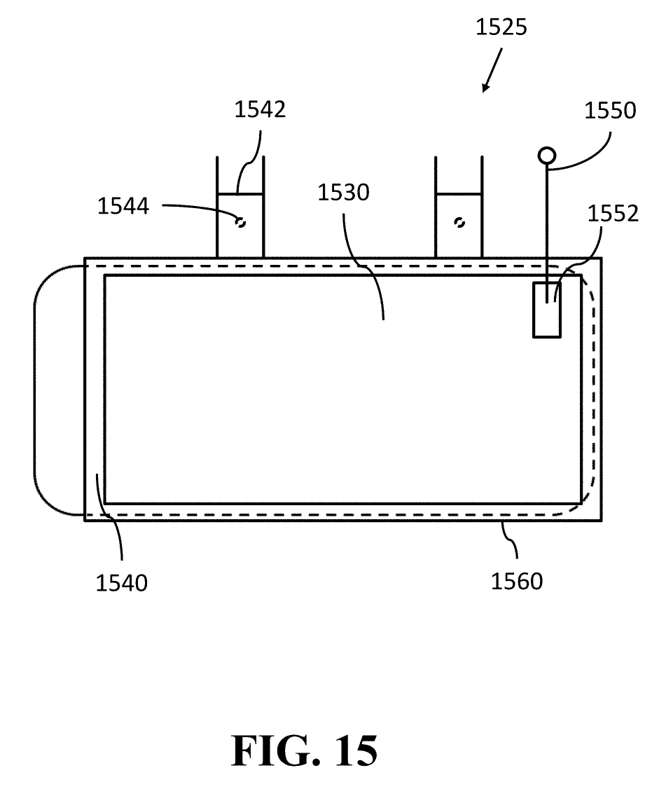

FIG. 15 illustrates a drag apparatus 1525 for a watercraft. Drag apparatus 1525 may attach to a portion of a hull of a watercraft. Drag apparatus 1525 may include a control surface 1530. Drag apparatus 1525 may include a mounting device 1540. Drag apparatus 1525 may include a handle 1550. Drag apparatus 1525 may include a lower seal 1560.

Mounting device 1540 may include at least one clamp 1542. At least one clamp may be configured to extend around two or more sides of a hull of a watercraft. At least one clamp may include at least one fixation member 1544.

Handle 1550 may include a handle plate 1552. Handle plate 1552 may connect to control surface 1530.

As illustrated, control surface 1530 may be in a retracted position. Control surface 1530's retracted position may be that position in which it is retracted as far as possible.

In one embodiment, drag apparatus 1525 may be configured such that control surface 1530 extends out of the port side of a watercraft. However, one may remove handle plate 1552, rotate control surface 1530 about its vertical axis, and reattach handle plate 1552, which will result in control surface 1530 extending out of the starboard side of a watercraft.

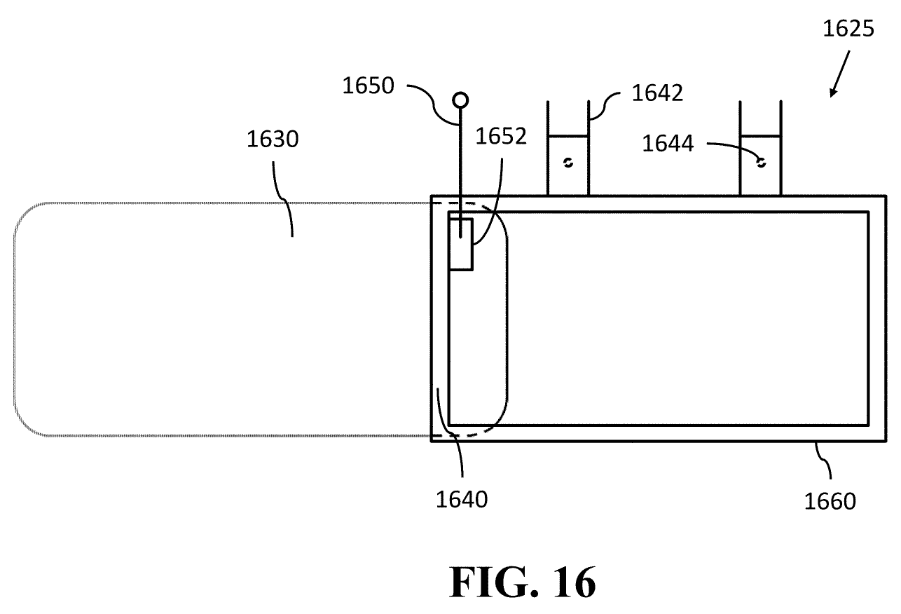

FIG. 16 illustrates a drag apparatus 1625 for a watercraft. Drag apparatus 1625 may attach to a portion of a hull of a watercraft. Drag apparatus 1625 may include a control surface 1630. Drag apparatus 1625 may include a mounting device 1640. Drag apparatus 1625 may include a handle 1650. Drag apparatus 1625 may include a lower seal 1660.

Mounting device 1640 may include at least one clamp 1642. At least one clamp may be configured to extend around two or more sides of a hull of a watercraft. At least one clamp may include at least one fixation member 1644.

Handle 1650 may include a handle plate 1652. Handle plate 1652 may connect to control surface 1630.

As illustrated, control surface 1630 may be in an extended position. Control surface 1630's extended position may be that position in which it is extended as far as possible. Handle plate 1652 may act as a “stop” to prevent control surface 1630 from extending farther than desired, as handle plate 1652 may contact mounting device 1640. Control surface 1630 may be partially extended or fully extended at a user's preference. Friction between control surface 1630 and mounting device 1640 may maintain control surface 1630 in a state of desired extension or retraction.

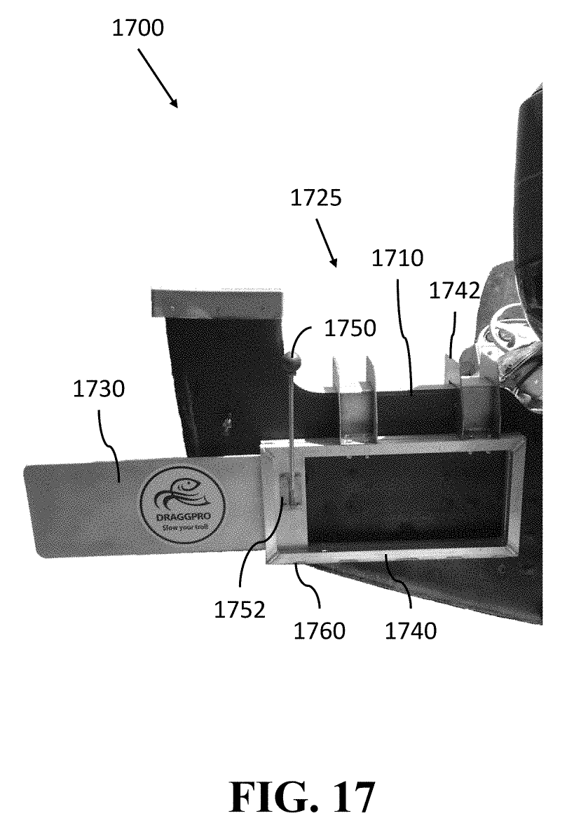

FIG. 17 illustrates a drag apparatus 1725 for a watercraft 1700. Drag apparatus 1725 may attach to a portion of a hull 1710 of watercraft 1700. Hull 1710 may be a transom. Drag apparatus 1725 may include a control surface 1730. Drag apparatus 1725 may include a mounting device 1740. Drag apparatus 1725 may include a handle 1750. Drag apparatus 1725 may include a lower seal 1760.

Mounting device 1740 may include at least one clamp 1742. At least one clamp may be configured to extend around two or more sides of hull 1710 of watercraft 1700, including a transom.

Handle 1750 may include a handle plate 1752. Handle plate 1752 may connect to control surface 1730. Handle plate 1752 may attach to control surface 1730 via bolts.

As illustrated, control surface 1730 may be in an extended position. Control surface 1730′s extended position may be that position in which it is extended as far as possible. Handle plate 1752 may act as a “stop” to prevent control surface 1730 from extending farther than desired, as handle plate 1752 may contact mounting device 1740.

Control surface 1730 may extend past the side of the stern of watercraft 1700. As illustrated, control surface 1730 may extend about 12 in. to 15 in. past the port side of watercraft 1700. Control surface 1730 may extend any distance past the port side of watercraft 1700, as desired by a user.

At least one clamp 1742 may connect to mounting device 1740 via bolts. Clamps 1742 may be replaced with any mounting device configured to mount drag apparatus 1725 to watercraft 1700, including the stern, transom, or port or starboard side of watercraft 1700. Clamps 1742 may be turned around, along with handle 1750 and handle plate 1752 to allow for mounting of drag apparatus near another portion of watercraft 1700 (e.g., the starboard stern), and thus causing control surface 1730 to extend off of the starboard side of watercraft 1700.

In practice, one may lack a trolling motor on one's watercraft. One's main engine may be too large, and operate with too much thrust to allow one to properly troll as slowly as one desires. One may cast trolling lines from a fishing apparatus (e.g., a fishing rod) into a body of water in which the watercraft operates, the lines having lures on the ends of the lines. The lures may be designed to rise in the water (vertically) upon an increase in velocity of the watercraft on the surface of the water, and the lures may be designed to fall (vertically) in the water upon a decrease in velocity of the watercraft on the surface of the water.

While traveling or before traveling, one may deploy a drag apparatus on one of a port side of a watercraft and a starboard side of a watercraft. As the watercraft moves along the surface of the water, the drag apparatus will cause a drag on the side of deployment, causing the side of deployment of the watercraft to decrease in velocity. As a result, any lures on lines on the side of the deployment of the drag apparatus may fall (vertically) deeper in the water, and such fall may be sudden. To the contrary, any lures on lines on the side opposite the side of deployment may rise (vertically) shallower in the water, and such rise may be sudden. Certain sport fish may prefer to strike upon a lure's sudden, or gradual, rising or falling in the water.

Deployment of the drag apparatus may cause the watercraft to change heading, turning at least somewhat in the direction of deployment of the drag apparatus. The operator of the watercraft may have to turn the watercraft away from the direction of deployment to avoid the watercraft turning in circles. When the operator turns the watercraft away from the direction of deployment to overcome the change in heading caused by drag, any lures on lines on the side of the deployment of the drag apparatus may now rise (vertically) as that side of the watercraft may see an increase in velocity. To the contrary, any lures on lines on the side opposite the deployment may fall (vertically) due to a reduction in velocity caused by turning. Once the operator corrects the heading of the water craft to overcome the drag, the operator may release the watercraft's steering wheel (or the like) and allow it to enter a neutral, 0 degree, orientation that would normally cause the watercraft to travel substantially straight ahead. However, due to drag caused by the drag apparatus, the watercraft may again change heading, turning at least somewhat in the direction of deployment of the drag apparatus, again causing the lures to rise or fall as a result.

In this manner, an operator of a watercraft can systematically cause lures to rise or fall while trolling, which may attract desired fish to engage those lures. Thus, the drag apparatus may act as both a tool to facilitate the systematic rising and falling of lures during trolling, as well as a teaching aid to teach an operator of a watercraft how to properly troll.

It is understood that without deployment of the drag apparatus, simply turning the wheel (or like device) on a watercraft does not cause that side of the watercraft oriented toward the inside of the turn to decrease in velocity, but rather simply causes that side of the watercraft on the outside of the turn to increase in velocity. Use of the drag apparatus, on the other hand, causes that side of the watercraft on the side of deployment of the drag apparatus, to slow, while causing the side of the watercraft on the side opposite of the drag apparatus, to speed up.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±6.35 millimeters (±0.25 inches). To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A drag apparatus for a watercraft, comprising:
at least one control surface configured to extend from the watercraft into a body of water,
wherein the at least one control surface is configured to extend from at least one of the port side and the starboard side of the watercraft,
wherein the at least one control surface is configured to disrupt a flow of water around at least one of the port side and the starboard side of the watercraft,
wherein the at least one control surface has a stowed position, at least one partially deployed position, and at least one deployed position, and
wherein the disruption of flow of water causes the watercraft to decrease in speed and to change heading; and
a control device having a first control end and a second control end,
wherein the first control end is configured to be operated by a watercraft pilot,
wherein the second control end is operatively connected to the at least one control surface, and
wherein the control device is configured to move the at least one control surface to and from at least one of: the stowed position, the at least one partially deployed position, and the at least one deployed position.

2. The drag apparatus of claim 1, further comprising: a mounting device having a first mounting end and a second mounting end,
wherein the first mounting end is operatively connected to the watercraft,
wherein the second mounting end is operatively connected to the at least one control surface.

3. The drag apparatus of claim 2, wherein the mounting device is configured to allow the at least one control surface to extend from the watercraft by at least one of: a rotation and a translation.

4. The drag apparatus of claim 1, wherein the control device is a handle.

5. The drag apparatus of claim 2, wherein the mounting device includes a clamp configured to connect to a hull of the watercraft.

6. The drag apparatus of claim 2, wherein the mounting device includes a clamp configured to connect to a transom of the watercraft.

7. A drag apparatus for a watercraft, comprising:
a mounting device, including at least one clamp, and two frame members having a channel between the frame members;
at least one control surface oriented within the channel;
wherein the at least one clamp extends around a portion of a hull of the watercraft;
wherein the at least one control surface is configured to translate between a stowed position and a deployed position;
wherein the at least one control surface is configured to disrupt a flow of water around at least one side of the watercraft; and
wherein the disruption of flow of water causes the watercraft to decrease in speed and to change heading.

8. The drag apparatus of claim 7, wherein the at least one clamp extends around a portion of three sides of the hull of the watercraft.

9. The drag apparatus of claim 8, wherein the hull includes a transom, and wherein the clamp extends around three sides of the transom of the watercraft.

10. The drag apparatus of claim 7, wherein the clamp includes a fixation member and a clamp surface, wherein the fixation member and the clamp surface are opposed to one another, and wherein fixation member the clamp surface apply a compression force to the hull.

11. The drag apparatus of claim 7, further comprising a handle, wherein the handle connects to the at least one control surface.

12. The drag apparatus of claim 11, further comprising a handle plate bolted to the at least one control surface, the handle plate connecting the handle to the at least one control surface.

13. The drag apparatus of claim 7, further comprising a lower seal extending along an edge of the mounting device opposite the at least one clamp and sealing the channel.

14. A watercraft including a drag apparatus, comprising:
a hull;
a mounting device, including at least one clamp, and two frame members having a channel between the frame members;
at least one control surface oriented within the channel;
wherein the at least one clamp extends around a portion of the hull;
wherein the at least one control surface translates between a stowed position and a deployed position;
wherein the at least one control surface disrupts a flow of water around at least one side of the watercraft; and
wherein the disruption of flow of water causes the watercraft to decrease in speed and to change heading.

15. The watercraft of claim 14, wherein the at least one clamp extends around a portion of three sides of the hull.

16. The watercraft of claim 15, wherein the hull includes a transom, and wherein the clamp extends around three sides of the transom.

17. The watercraft of claim 14, wherein the clamp includes a fixation member and a clamp surface, wherein the fixation member and the clamp surface are opposed to one another, and wherein fixation member the clamp surface apply a compression force to the hull.

18. The watercraft of claim 14, further comprising a handle, wherein the handle connects to the at least one control surface.

19. The watercraft of claim 18, further comprising a handle plate bolted to the at least one control surface, the handle plate connecting the handle to the at least one control surface.

20. The watercraft of claim 14, further comprising a lower seal extending along an edge of the mounting device opposite the at least one clamp and sealing the channel.
